(19) United States
(12) Patent Application Publication
(10) Pub. No.: US 2026/0200519 A1
(43) Pub. Date: Jul. 16, 2026

(54) KINGPIN STEERING AND OMNI-DIRECTIONAL STEERING DUAL-MODE POWER-MULTIPLEXING ELECTRIC WHEEL ANGLE MODULE

(71) Applicant: Jilin University, Changchun (CN)

(72) Inventors: Junnian WANG, Changchun (CN); Bailin LIANG, Changchun (CN); Wentao HU, Changchun (CN); Yinghan YANG, Changchun (CN); Yitong WANG, Changchun (CN); Chenyong ZHANG, Changchun (CN)

(21) Appl. No.: 19/446,848

(22) Filed: Jan. 12, 2026

(30) Foreign Application Priority Data
Jan. 13, 2025 (CN) 202510046647.6

(51) Int. Cl. B62D 5/04; B62D 7/18

(52) U.S. Cl. CPC B62D 5/0418; B62D 7/18

(57) ABSTRACT

Disclosed is a kingpin steering and omni-directional steering dual-mode power-multiplexing electric wheel angle module, which ingrates a wheel unit, a suspension system, a vibration damping system, an electromechanical braking system, a super capacitor and a steering system. The steering system is a kingpin steering and omni-directional steering dual-mode steering system, in which wheels steer around a virtual kingpin in a kingpin steering mode, so that the steering system has low steering delay and high-speed driving operation stability; and the omni-directional steering mode serves as a redundancy scheme of the kingpin steering mode, which achieves omni-directional steering of the whole angle module relative to a vehicle body, so that the steering system meets a maneuverability requirement of a low-speed vehicle. A set of steering motor and planetary gear reducer is multiplexed in kingpin steering and omni-directional steering, and the modes are switched through a mode switching mechanism.

### CROSS REFERENCE TO RELATED APPLICATIONS

This application claims foreign priority of Chinese Patent Application No. 202510046647.6, filed on January 13, 2025 in the China National Intellectual Property Administration, the disclosures of all of which are hereby incorporated by reference.

### TECHNICAL FIELD

The present invention relates to an angle module device applied to an electric vehicle, and particularly to a vehicle angle module device integrating a wheel unit, a suspension system, a vibration damping system, an electromechanical braking system, a super capacitor and a steering system.

### BACKGROUND OF THE PRESENT INVENTION

In 2020, the chassis integration of pure electric vehicles, the drive-by-wire execution system, and the like were listed as key technology breakthrough projects in the “Development Plan for the New Energy Vehicle Industry (2021-2035)” issued by the State Council. The requirement that no full-power steering mechanism was allowed to be mounted was deleted from the national standard “GB17675-2021 Steering System of Motor Vehicles - Basic Requirements”, which indicated that physical decoupling between a steering wheel and a steering gear of a steering system has been allowed legally. Compared with traditional steering forms, steer-by-wire steering has the advantages of simple structure, fast response speed, rich functions, and the like. However, due to the lack of mechanical connection between the steering system and the steering wheel, vehicle driving safety is threatened. Therefore, the addition of a redundant system for vehicles adopting the steer-by-wire steering must be taken into account to ensure that the vehicles will not completely lose the steering ability after the main steering system fails.

Meanwhile, with the gradual complexity of urban road traffic and the diversification of vehicle application scenes, a traditional front wheel steering form has been insufficient to meet the needs of consumers. Therefore, vehicles with a four-wheel omni-directional steering function have a great engineering practice potential and a broad product market because of excellent maneuverability. At present, one of the important reasons that restrict the four-wheel omni-directional steering technology is a large weight and a large occupation space of a hub motor, and if a steering system with an omni-directional steering function is added at a wheel edge, the unsprung mass will be excessively large, and the structure will be excessively complicated. Therefore, the achievement of four-wheel omni-directional steering on the premise of reducing the unsprung mass as much as possible and improving the system integration has become the research focus in this direction.

In addition, with the continuous expansion of scale of an active suspension system in the global market, people have increasingly requirements for suspension performance, and gradually pay attention to active adjustment control and active energy regeneration functions of a suspension. Therefore, traditional passive suspensions with an unadjustable damping stiffness can no longer meet the requirements. Meanwhile, with the progress of chassis intelligentization and electrification, a wheel angle module, serving as a highly integrated electromechanical system, provides more controllable degrees of freedom for whole vehicle dynamics and vehicle body attitude control.

In addition, in the face of frequent start and stop under urban operating conditions, a vehicle-mounted power battery with a single power supply needs to be frequently charged and discharged, which will lead to excessive load fluctuation and low efficiency of the vehicle-mounted power battery, thereby causing battery heating and service life attenuation. At present, one of the solutions to this problem is a composite power supply system formed by a super capacitor and the vehicle-mounted power battery, which makes full use of high energy density of the vehicle-mounted power battery and high power density of the super capacitor, thereby improving the working efficiency of a power system and prolonging the service life of the vehicle-mounted power battery. Meanwhile, a self-energy storage function of the wheel angle module can be achieved by adding the super capacitor as an energy backup, thereby improving the vehicle driving safety when the vehicle-mounted power battery fails.

To sum up, there is now an urgent need for a highly integrated system of a wheel angle module with the characteristics of safety redundancy and low unsprung mass, as well as the four-wheel omni-directional steering function and the active suppression and energy regeneration functions of the suspension. Meanwhile, the system should have the functions of self-energy storage and quick disassembly and assembly.

### SUMMARY OF THE PRESENT INVENTION

According to the background of the times, a wheel angle module is designed herein, which integrates a drive-brake-steer-suspension system, has a kingpin steering and omni-directional steering dual-mode steering function, and can achieve capabilities of self-energy storage and quick disassembly and assembly with a vehicle body.

A technical solution of the present invention is: a kingpin steering and omni-directional steering dual-mode power-multiplexing electric wheel angle module, which includes:

a wheel unit (1000), which is connected with a steering knuckle in a suspension system through a hub bearing, and internally integrated with a hub motor at the same time, wherein the wheel unit is configured for supporting a vehicle load, and contacting with a road surface to transmit a driving or braking force and a cornering lateral force;

the suspension system (2000), which is an unequal-length double wishbone suspension, and mainly used for transmitting a force and a torque acting between wheels and a vehicle body, connecting various system components, and determining wheel positioning parameters;

a vibration damping system (3000), which is connected with a lower control arm and a lower end of a steering arm housing of the suspension system, and used for actively controlling a suspension attitude and recovering wheel vibration energy through a vibration damping motor, and mitigating an impact on a road surface through a vibration damping spring;

an electromechanical braking system (4000), which is connected with lugs on a left side of the steering knuckle in the suspension system through bolts, and used for providing a braking torque for vehicle driving;

a steering system (6000), which is a kingpin steering and omni-directional steering dual-mode steering system, wherein an omni-directional steering mode serves as a redundancy scheme of a kingpin steering mode, and the same set of steering motor and planetary gear reducer is multiplexed in the two steering modes to work; when the kingpin steering mode is adopted, in the case of driving through the steering motor, speed reduction and torque multiplication through the planetary gear reducer, and connection with the steering knuckle of the suspension system through a universal transmission device, a steering torque is transmitted; when the omni-directional steering mode is adopted, in the case of driving through the steering motor, speed reduction and torque multiplication through the planetary gear reducer, and upward movements of a shift fork and a locking fork driven by a shift motor, a shift gear mechanism is driven to be disconnected from the universal transmission device and meshed with an omni-directional steering input gear, and finally, the steering torque output by the steering motor is output through an angle module output shaft, and meanwhile, an angle module quick interface is connected with the vehicle body to achieve omni-directional steering; and in addition, the upward movement of the locking fork drives a locking joint sleeve to be connected with a locking splined hub, and meanwhile, an external spline of the locking joint sleeve is connected with the steering arm housing of the suspension system, so that a locking function of the steering knuckle relative to the steering arm housing is achieved; and

a super capacitor (5000), which is mounted inside the steering arm housing in the suspension system, matched with a vehicle-mounted power battery, and used for providing electric energy for the vibration damping system, the electromechanical braking system and the steering system during working, and storing electric energy recovered from braking and vibration energy, so that self-energy storage and whole vehicle energy redundancy safety design of the kingpin steering and omni-directional steering dual-mode power-multiplexing electric wheel angle module are achieved.

Preferably, the wheel unit (1000) includes:

a tire (1100), which is used for bearing a whole vehicle load, and transmitting road force and torque;

a rim (1200), wherein an end portion of the rim is provided with spokes, an exterior of the rim is used for mounting the tire (1100), and a through hole is arranged inside a center of the rim;

a hub flange (1300), wherein an interior of the hub flange is provided with a through hole through which a positioning pin of an outer rotor of the hub motor (1400) penetrates for positioning, and the hub flange is connected with the spokes of the rim (1200) through flange nuts;

the hub motor (1400), which is a low-speed outer rotor hub motor, wherein a stator of the hub motor is connected with a through hole in a middle portion of the steering knuckle (2300) through bolts, the outer rotor of the hub motor is connected with the rim (1200) and the hub flange (1300) through rim bolts, and meanwhile, an outer ring of the outer rotor is provided with a threaded hole for mounting a brake disc (1500); and

the brake disc (1500), which is connected with the outer rotor of the hub motor (1400) through bolts, and provided with a brake clearance with a brake caliper in the electromechanical braking system (4000).

Preferably, the suspension system (2000) includes:

the lower control arm (2100), which has an A-shape as a whole, and is provided with two intersected swing arms and one transverse arm, wherein a ball pin support is arranged at an intersected part of the swing arms and connected with a lower ball pin support of the steering knuckle (2300) through a ball pin, boss through holes are arranged in the other ends of the swing arms, and connected with a steering arm (2600) through shaft sleeves and bolts, and lugs are arranged on a top surface of the transverse arm to be connected with a vibration damper bracket in the vibration damping system (3000) through pins;

an upper control arm (2200), which has a V-shape as a whole, and is composed of two intersected swing arms, wherein a ball pin support is arranged at an intersected part of the swing arms and connected with an upper ball pin support of the steering knuckle (2300) through a ball pin, and boss through holes are arranged in the other ends of the swing arms, and connected with the steering arm (2600) through shaft sleeves and bolts;

the steering knuckle (2300), wherein a center connecting line between the ball pin supports of the upper and lower control arms forms a kingpin, a through hole is arranged in a middle portion of the steering knuckle for mounting a stator of the hub motor (1400), and lugs are arranged on a left side of the steering knuckle for bolt connection with the electromechanical braking system (4000);

the steering arm housing (2400), which is mainly used for arranging and positioning various system components, and protecting the system components from being damaged, wherein an upper end of the steering arm housing is provided with a bolt hole, a bottom portion of the steering arm housing is provided with a through hole, and meanwhile, an inner side of the through hole is provided with a sliding spline;

the angle module quick interface (2500), wherein a top portion of the angle module quick interface is connected with the vehicle body, and a bottom portion of the angle module quick interface is connected with the angle module output shaft of the steering system (6000) through a cylindrical pin; and

the steering arm (2600), which is an L-shaped bracket as a whole, wherein two sides of a lower end of the steering arm are connected with the boss through holes of the lower control arm (2100) through the shaft sleeves and the bolts, lugs are arranged on an inner side of a middle portion of the steering arm to be connected with the boss through holes of the upper control arm (2200) through the shaft sleeves and the bolts, symmetrical reinforcing ribs are additionally arranged at an L-shaped corner, an upper end of the steering arm is provided with a threaded hole for mounting the steering motor of the steering system (6000), and an outer edge of a top portion of the steering arm (2600) is provided with a bolt hole for mounting the steering arm housing (2400).

Preferably, the vibration damping system (3000) includes:

the vibration damper bracket (3100), which is used for supporting and positioning the vibration damping system (3000), wherein two supporting arms at a lower portion of the vibration damper bracket are provided with boss through holes to be connected with the lugs of the lower control arm (2200) through pins;

an actuator (3200), wherein a core of the actuator is a screw-nut electromechanical mechanism, and the actuator is fixedly connected with an upper mounting hole of the vibration damper bracket (3100) through bolts;

a vibration damping spring (3300), which is coaxially arranged with the actuator (3200) for supporting and impact mitigation;

the vibration damping motor (3400), which is a rotating motor, and used for actively controlling the suspension attitude and recovering the wheel vibration energy; and

a vibration damping motor output shaft (3500), which is used for transmitting an output torque of the vibration damping motor (3400) to the actuator (3200), wherein a top end of the vibration damping motor output shaft is connected with an output end of the vibration damping motor (3400) through a spline, and a bottom end of the vibration damping motor output shaft is connected with the actuator (3200) through a pin.

Preferably, the actuator (3200) includes:

an actuator upper cover (3210), wherein lugs are arranged at a top portion of the actuator upper cover to be connected with the lugs at the bottom end of the steering arm housing (2400) through bolts, a bottom portion of the actuator upper cover has a flange structure, and a through hole is arranged in a center of the actuator upper cover for the vibration damping motor output shaft (3500) to pass through;

a double-row angular contact ball bearing (3220), wherein an inner end of the double-row angular contact ball bearing is matched with the vibration damping motor output shaft (3500);

a vibration damping system constant velocity universal joint (3230), wherein a top portion of the vibration damping system constant velocity universal joint is connected with the bottom end of the vibration damping motor output shaft (3500) through a pin, and meanwhile, the double-row angular contact ball bearing (3220) is axially positioned;

an actuator upper shell (3240), wherein a top portion of the actuator upper shell is connected with the flange structure of the actuator upper cover (3210) through bolts, an exterior of the actuator upper shell is provided with a groove for positioning the vibration damping spring (3300), an interior of the actuator upper shell is matched with an outer end of the double-row angular contact ball bearing (3220), and a bottom portion of the actuator upper shell is provided with a dust cover to protect a transmission mechanism;

a lead screw (3250), wherein a top portion of the lead screw is connected with the vibration damping system constant velocity universal joint (3230) through a spline;

a ball nut (3260), which is matched with the lead screw (3250) to convert a rotary motion of the lead screw (3250) into a linear motion of the ball nut (3260);

an actuator connecting sleeve (3270), wherein a top portion of the actuator connecting sleeve is fixedly connected with the ball nut (3260) through a pin, and an interior of the actuator connecting sleeve is provided with a deep hole to supply sufficient space for the lead screw (3250); and

an actuator lower shell (3280), wherein an interior of the actuator lower shell is matched with the actuator connecting sleeve (3270) and the actuator lower shell is connected with the actuator connecting sleeve through bolts, an exterior of the actuator lower shell is provided with a groove for positioning the vibration damping spring (3300), and a bottom portion of the actuator lower shell is provided with a supporting rod to be connected with the vibration damper bracket (3100).

Preferably, the electromechanical braking system (4000) includes:

an electromechanical braking actuator, which mainly includes an electromechanical braking actuator motor, an electromechanical braking reducer and a transmission mechanism thereof, and is used for providing a brake clamping torque;

a brake caliper (4100), which is driven by the electromechanical braking actuator to clamp the brake disc (1500) to achieve a braking function; and

a braking system housing (4200), which is used for protecting and positioning various devices inside the electromechanical braking system (4000), wherein lugs are arranged on two sides to be connected with the lugs on the left side of the steering knuckle (2300) through bolts at the same time.

Preferably, the steering system (6000) includes:

the steering motor (6100), which is a rotating motor, wherein lugs are arranged at a top portion of the steering motor to be connected with the steering arm (2600);

a shift gearbox (6700), which is an integrated device of shift and transmission devices of the kingpin steering and omni-directional steering dual-mode steering system, wherein a bottom portion of the shift gearbox is fixed by a positioning groove arranged in the steering arm housing (2400); the angle module output shaft (6200), wherein a top portion of the angle module output shaft is connected with the angle module quick interface (2500) through a cylindrical pin, and a bottom portion of the angle module output shaft is connected with the shift gearbox (6700);

a thrust bearing (6300), which is sleeved in a middle portion of the angle module output shaft (6200), axially positioned by using a stepped hole in an outer side of the steering arm (2600), and matched with a deep groove ball bearing to jointly support the angle module output shaft (6200) in the stepped hole in the outer side of the steering arm (2600), so as to ensure that the angle module output shaft (6200) is positioned relative to the steering arm (2600);

the planetary gear reducer (6400), which plays a role of speed reduction and torque multiplication, wherein an upper end of the planetary gear reducer is connected with an output end of the steering motor (6100) through a spline, and a lower end of the planetary gear reducer is connected with the shift gear mechanism in the shift gearbox (6700) through a spline;

a shift control mechanism (6500), which is used for kingpin steering and omni-directional steering dual-mode switching; and

the universal transmission device (6600), which includes two constant velocity universal joints, wherein an input end of a first constant velocity universal joint is connected with the shift gear mechanism in the shift gearbox (6700) through a spline, an output end of the first constant velocity universal joint is connected with an input end of a second constant velocity universal joint through a spline, and an output end of the second constant velocity universal joint is connected with an internal splined hole in a top portion of the steering knuckle (2300) through a spline.

Preferably, the planetary gear reducer (6400) includes:

a reducer housing (6410), which is used for positioning and protecting various transmission devices inside the planetary gear reducer (6400), wherein lugs are arranged on one side of an interior of the reducer housing provided with a rack structure and used with a positioning groove for mounting the shift motor of the shift control mechanism (6500);

a reducer upper cover (6420), which is connected with a top portion of the reducer housing (6410) through screws;

an input splined shaft (6430), wherein an upper end of the input splined shaft penetrates through a through hole arranged in a center of the reducer upper cover (6420), and the input splined shaft is connected with the output end of the steering motor (6100) through a spline;

a two-stage planetary gear train (6440), which includes two planetary gear mechanisms, wherein a rack part is provided by the rack structure arranged inside the reducer housing (6410), a primary sun gear is connected with the input splined shaft (6430) through a parallel key, a primary planetary carrier is connected with a secondary sun gear through a parallel key, and a bottom end of a secondary planetary carrier is provided with a parallel key; and connected with an upper end of an output splined shaft (6450) through the parallel key; and

the output splined shaft (6450), wherein the upper end of the output splined shaft is connected with the secondary planetary carrier in the two-stage planetary gear train (6440) through the parallel key, and a lower end of the output splined shaft is connected with the shift gear mechanism in the shift gearbox (6700) through a spline.

Preferably, the shift control mechanism (6500) includes:

the shift motor (6510), which is a linear motor, provides actuating power for the kingpin steering and omni-directional steering dual-mode switching, and is divided into “upper” and “lower” gears respectively corresponding to the two modes of omni-directional steering and kingpin steering, wherein an upper end of the shift motor is fixedly connected with the lugs on the outer side of the reducer housing (6410) and the positioning groove through bolts at the same time;

a shift stepped shaft (6520), which adopts a stepped shaft design, wherein an upper end of the shift stepped shaft is connected with an output end of the shift motor (6510), and the shift stepped shaft is provided with upper and lower shaft shoulders;

the shift fork (6530), which has a U-shape as a whole, wherein one side of the shift fork is provided with a through hole for axial positioning through the upper shaft shoulder of the shift stepped shaft (6520), and the shift fork is fixed through a fastening nut pair, and the other side of the shift fork is connected with the shift gear mechanism in the shift gearbox (6700);

the locking splined hub (6540), which is provided with an internal spline to be in splined connection with the input end of the first constant velocity universal joint of the universal transmission device (6600), and used for achieving a locking function of the steering knuckle (2300) relative to the steering arm housing (2400) when the system is in the omni-directional steering mode or is switched to the omni-directional steering mode;

the locking fork (6550), which has a U-shape as a whole, wherein one side of the locking fork is provided with a through hole for axial positioning through the lower shaft shoulder of the shift stepped shaft (6520), and the locking fork is fixed through a fastening nut pair, and the other side of the locking fork is inserted into the locking joint sleeve of the shift control mechanism (6500) for connection; and

the locking joint sleeve (6560), which is provided with an external spline to be connected with the sliding spline of the through hole in the bottom portion of the steering arm housing (2400), and provided with a fork groove to be connected with the locking fork (6550), wherein, when the system is in the omni-directional steering mode or is switched to the omni-directional steering mode, the locking joint sleeve is driven to move up by the locking shift fork (6550), and connected with the locking splined hub (6540) through an internal spline arranged inside the locking joint sleeve, so as to achieve a locking function of the steering knuckle (2300) relative to the steering arm housing (2400).

Preferably, the shift gearbox (6700) includes:

a shift gearbox housing (6710), which is used for positioning and protecting various shift transmission devices inside the shift gearbox (6700), wherein a top portion of the shift gearbox housing is provided with a threaded hole, and a bottom portion of the shift gearbox housing is fixed by a positioning groove in the bottom portion of the steering arm housing (2400);

a shift gearbox upper cover (6720), which is provided with a through hole, and connected with a threaded hole in the top portion of the shift gearbox housing (6710) through a screw;

the shift gear mechanism (6730), which is composed of a shift gear and a shift shaft sleeve which are connected through a parallel key, wherein the shift gear is positioned through shaft shoulders of the shift shaft sleeve, the shift shaft sleeve is provided with the shift fork groove to be connected with the shift fork (6530), an upper end of the shift gear mechanism is provided with a splined hole to be constantly connected with the output splined shaft (6450), and meanwhile, sufficient axial displacement space is reserved for shift operation, and a lower end of the shift gear mechanism is provided with a splined hole, wherein, when the system is in the kingpin steering mode, the shift gear mechanism is controlled to move down by the shift control mechanism (6500) and connected with the universal transmission device (6600), and when the system is in the omni-directional steering mode, the shift gear mechanism is controlled to move up by the shift control mechanism (6500) and disconnected from the universal transmission device (6600);

an omni-directional steering input gear (6740), which is positioned by using a positioning pin of the shift gearbox housing (6710) and a boss through the shaft sleeve, so as to ensure that a target steering direction of the omni-directional steering mode is the same as that of the kingpin steering mode while transmitting a steering torque, wherein, when the system is in the kingpin steering mode, the shift gear mechanism (6730) is controlled to move down through the shift control mechanism (6500), so that the shift gear of the shift gear mechanism (6730) is connected with the omni-directional steering input gear (6740), and when the system is in the omni-directional steering mode, the shift gear mechanism (6730) is controlled to move up through the shift control mechanism (6500), so that the shift gear of the shift gear mechanism (6730) is offset from the omni-directional steering input gear (6740) for disconnection; and

an omni-directional steering output gear (6750), which is connected with the angle module output shaft (6200) through a parallel key, axially positioned through a retaining ring, and constantly meshed with the omni-directional steering input gear (6740).

Preferably, the steering system (6000) is a kingpin steering and omni-directional steering dual-mode steering system, and working modes and control methods of the steering system include that:

the same set of steering motor (6100) and planetary gear reducer (6400) is multiplexed in the kingpin steering mode and the omni-directional steering mode to work;

in the kingpin steering mode, the shift motor (6510) is extended to be in a “down” gear position, and the shift fork (6530) and the locking fork (6550) move down synchronously, so that the shift shaft sleeve of the shift gear mechanism (6730) is connected with the universal transmission device (6600), and meanwhile, the locking joint sleeve (6560) moves down to be disconnected from the locking splined hub (6540) for unlocking, and in the case, the steering torque of the kingpin steering and omni-directional steering dual-mode power-multiplexing electric wheel angle module is provided by the steering motor (6100), subjected to the speed reduction and torque multiplication by the planetary gear reducer (6400), and then transmitted to the steering knuckle (2300) through the universal transmission device (6600), so that the kingpin steering and omni-directional steering dual-mode power-multiplexing electric wheel angle module actively controls conventional steering movement of the wheel unit (1000) around the kingpin according to a rotation signal of a steering wheel; and

in the omni-directional steering mode, the shift motor (6510) is retracted to be in an “up” gear position, and the shift fork (6530) and the locking fork (6550) move up synchronously, so that the shift shaft sleeve of the shift gear mechanism (6730) is disconnected from the universal transmission device (6600), the shift gear is meshed with the omni-directional steering input gear (6740), and meanwhile, the locking joint sleeve (6560) moves up to be connected with the locking splined hub (6540) for locking, and in the case, the steering torque of the kingpin steering and omni-directional steering dual-mode power-multiplexing electric wheel angle module is provided by the steering motor (6100), subjected to the speed reduction and torque multiplication by the planetary gear reducer (6400), finally transmitted to the angle module output shaft (6200) and the angle module quick interface (2500) for output through a meshing relationship of the shift gear of the shift gear mechanism (6730) with the omni-directional steering input gear (6740) and the omni-directional steering output gear (6750), and then transmitted to the steering knuckle (2300) through the universal transmission device (6600), so that the kingpin steering and omni-directional steering dual-mode power-multiplexing electric wheel angle module actively controls omni-directional steering of the wheel unit as a whole relative to the vehicle body according to the rotation signal of the steering wheel;

control of kingpin steering and omni-directional steering dual-mode switching is mainly divided into passive control and active control, and includes that:

under the passive control: the omni-directional steering mode serves as the steering redundancy scheme of the kingpin steering mode, and when the kingpin steering mode works normally, the kingpin steering mode is adopted to work; and when the kingpin steering mode fails to work, the mode is automatically switched to the omni-directional steering mode to work; and

under the active control: in the case that steering is not required or only steering at an angle below a threshold angle is required, which refers to no steering or small angle steering, the kingpin steering mode is adopted, which is usually used for steering at medium and high vehicle speeds; and in the case that steering above the threshold angle is required, which refers to large angle or full angle steering, the omni-directional steering mode is adopted, which is usually used for high-mobility steering at a low speed.

The present invention has the beneficial effects as follows.

1. The present invention provides the kingpin steering and omni-directional steering dual-mode power-multiplexing electric wheel angle module, which integrates the wheel unit, the suspension system, the vibration damping system, the electromechanical braking system and the steering system, achieves high integration of an electric vehicle chassis, improves modularization of a wheel-end system, is matched with various types of vehicles with different numbers of drive shafts, reduces a development cost of a whole vehicle, and may also be combined with different types of vehicle angle modules according to scene requirements to meet the personalized demand of multi-purpose of one vehicle.

2. The present invention provides the kingpin steering and omni-directional steering dual-mode power-multiplexing electric wheel angle module, which has a kingpin steering and omni-directional steering dual-mode steering scheme, the two modes are mutually redundant and complementary, and may also be matched with a differential action of the hub motor to form three mutually complementary steering systems, thereby greatly improving a maneuverability of the whole vehicle, and in addition, the same set of steering motor and planetary gear reducer is multiplexed in the kingpin steering mode and the omni-directional steering mode, which can significantly reduce a mass of the whole vehicle, reduce use of executive parts and save costs, and meanwhile, both of the steering motor and the planetary gear reducer are distributed on a sprung mass, which is beneficial for improving driving comfort and operating performance of the vehicle.

3. The present invention provides the kingpin steering and omni-directional steering dual-mode power-multiplexing electric wheel angle module, in which the vibration damping system may suppress suspension vibration through active control of the vibration damping motor, thereby improving an energy utilization rate of the whole vehicle by vibration energy recovery while improving riding comfort, and in addition, four vibration damping systems may be matched with each other for active energy regeneration of the suspension, so that a coordinated control function of a left and right suspension or a front and rear suspension similar to a cross-linked suspension is achieved, and a roll or pitch stiffness of the vehicle can be actively improved under steering or sudden acceleration and deceleration of the vehicle, thereby effectively controlling a vehicle body attitude.

4. The present invention provides the kingpin steering and omni-directional steering dual-mode power-multiplexing electric wheel angle module, in which the super capacitor will be matched with the vehicle-mounted power battery to work, so as to form the composite power supply system to provide and store energy for various systems in the kingpin steering and omni-directional steering dual-mode power-multiplexing electric wheel angle module, which can reduce a surge load caused by frequent start and stop of the vehicle-mounted power battery under urban operating conditions, and avoid the problem of overflow of energy recovered by regenerative braking and regenerative vibration due to insufficient residual capacity of the vehicle-mounted power battery at the same time, thereby effectively prolonging service life of the vehicle-mounted power battery, and in addition, the super capacitor enables the kingpin steering and omni-directional steering dual-mode power-multiplexing electric wheel angle module to have a self-energy storage function, and may serve as an energy backup scheme for the whole vehicle, and when the vehicle-mounted power battery fails, energy stored in the super capacitor may be supplied to the kingpin steering and omni-directional steering dual-mode power-multiplexing electric wheel angle module to complete an emergency action until the vehicle is stopped safely.

5. The present invention further provides the control method for the kingpin steering and omni-directional steering dual-mode switching of the kingpin steering and omni-directional steering dual-mode power-multiplexing electric wheel angle module, which introduces passive control and active control schemes in detail from perspectives of safety redundancy and scenario driving respectively, and this method has certain universality and reference significance, and may play the same role in other integrated angle module systems with similar structural scheme.

### DESCRIPTION OF THE DRAWINGS

FIG. 1 is an axonometric drawing of a kingpin steering and omni-directional steering dual-mode power-multiplexing electric wheel angle module according to the present invention;

FIG. 2 is a side view of the kingpin steering and omni-directional steering dual-mode power-multiplexing electric wheel angle module according to the present invention;

FIG. 3 is a sectional view of a vibration damping system of the kingpin steering and omni-directional steering dual-mode power-multiplexing electric wheel angle module according to the present invention;

FIG. 4 is an axonometric drawing of a steering system of the kingpin steering and omni-directional steering dual-mode power-multiplexing electric wheel angle module according to the present invention;

FIG. 5 is a diagram of a torque transmission path of the steering system of the kingpin steering and omni-directional steering dual-mode power-multiplexing electric wheel angle module according to the present invention (in a kingpin steering mode);

FIG. 6 is a diagram of a torque transmission path of the steering system of the kingpin steering and omni-directional steering dual-mode power-multiplexing electric wheel angle module according to the present invention (in an omni-directional steering mode); and

FIG. 7 is a flow chart of control of kingpin steering and omni-directional steering dual-mode switching of the kingpin steering and omni-directional steering dual-mode power-multiplexing electric wheel angle module according to the present invention.

### DETAILED DESCRIPTION OF PREFERRED EMBODIMENTS

The present invention is further described in detail hereinafter with reference to the drawings, so that those skilled in the art can implement according to the specification.

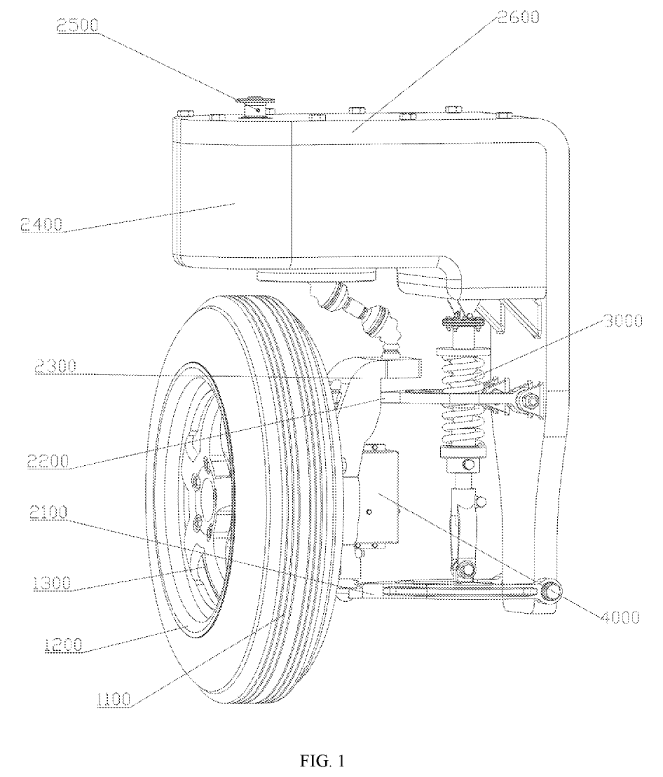

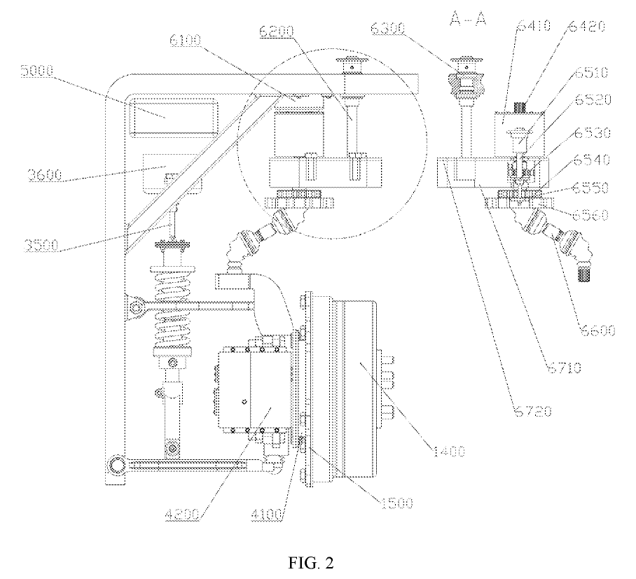

The present invention provides a kingpin steering and omni-directional steering dual-mode power-multiplexing electric wheel angle module, which, as shown in FIG. 1 and FIG. 2, mainly includes a wheel unit (1000), a suspension system (2000), a vibration damping system (3000), an electromechanical braking system (4000), a super capacitor (5000) and a steering system (6000).

The wheel unit (1000) is connected with a steering knuckle in a suspension system through a hub bearing, and internally integrated with a hub motor at the same time, wherein the wheel unit is configured for supporting a vehicle load, and contacting with a road surface to transmit a driving or braking force and a cornering lateral force. The wheel unit mainly includes a tire (1100), a rim (1200), a hub flange (1300), a hub motor (1400) and a brake disc (1500).

The tire (1100) is used for bearing a whole vehicle load, and transmitting road force and torque. As for the rim (1200), an end portion of the rim is provided with spokes, an exterior of the rim is used for mounting the tire (1100), and a through hole is arranged inside a center of the rim. As for the hub flange (1300), an interior of the hub flange is provided with a through hole through which a positioning pin of an outer rotor of the hub motor (1400) penetrates for positioning, and the hub flange is connected with the spokes of the rim (1200) through flange nuts. The hub motor (1400) is a low-speed outer rotor hub motor, wherein a stator of the hub motor is connected with a through hole in a middle portion of the steering knuckle (2300) through bolts, the outer rotor of the hub motor is connected with the rim (1200) and the hub flange (1300) through rim bolts, and meanwhile, an outer ring of the outer rotor is provided with a threaded hole for mounting the brake disc (1500). The brake disc (1500) is connected with the outer rotor of the hub motor (1400) through bolts, and provided with a brake clearance with a brake caliper in the electromechanical braking system (4000).

The suspension system (2000) is an unequal-length double wishbone suspension, and mainly used for transmitting a force and a torque acting between wheels and a vehicle body, connecting various system components, and determining wheel positioning parameters. The suspension system mainly includes a lower control arm (2100), an upper control arm (2200), the steering knuckle (2300), a steering arm housing (2400), an angle module quick interface (2500) and a steering arm (2600).

The lower control arm (2100) has an A-shape as a whole, and is provided with two intersected swing arms and one transverse arm, wherein a ball pin support is arranged at an intersected part of the swing arms and connected with a lower ball pin support of the steering knuckle (2300) through a ball pin, boss through holes are arranged in the other ends of the swing arms, and connected with the steering arm (2600) through shaft sleeves and bolts, and lugs are arranged on a top surface of the transverse arm to be connected with a vibration damper bracket in the vibration damping system (3000) through pins. The upper control arm (2200) has a V-shape as a whole, and is composed of two intersected swing arms, wherein a ball pin support is arranged at an intersected part of the swing arms and connected with an upper ball pin support of the steering knuckle (2300) through a ball pin, and boss through holes are arranged in the other ends of the swing arms, and connected with the steering arm (2600) through shaft sleeves and bolts. As for the steering knuckle (2300), a center connecting line between the ball pin supports of the upper and lower control arms forms a kingpin, a through hole is arranged in a middle portion of the steering knuckle for mounting a stator of the hub motor (1400), and lugs are arranged on a left side of the steering knuckle for bolt connection with the electromechanical braking system (4000). The steering arm housing (2400) is mainly used for arranging and positioning various system components, and protecting the system components from being damaged, wherein an upper end of the steering arm housing is provided with a bolt hole, a bottom portion of the steering arm housing is provided with a through hole, and meanwhile, an inner side of the through hole is provided with a sliding spline. As for the angle module quick interface (2500), a top portion of the angle module quick interface is connected with the vehicle body, and a bottom portion of the angle module quick interface is connected with an angle module output shaft of the steering system (6000) through a cylindrical pin. The steering arm (2600) is an L-shaped bracket as a whole, wherein two sides of a lower end of the steering arm are connected with the boss through holes of the lower control arm (2100) through the shaft sleeves and the bolts, lugs are arranged on an inner side of a middle portion of the steering arm to be connected with the boss through holes of the upper control arm (2200) through the shaft sleeves and the bolts, symmetrical reinforcing ribs are additionally arranged at an L-shaped corner, an upper end of the steering arm is provided with a threaded hole for mounting a steering motor of the steering system (6000), and an outer edge of a top portion of the steering arm (2600) is provided with a bolt hole for mounting the steering arm housing (2400).

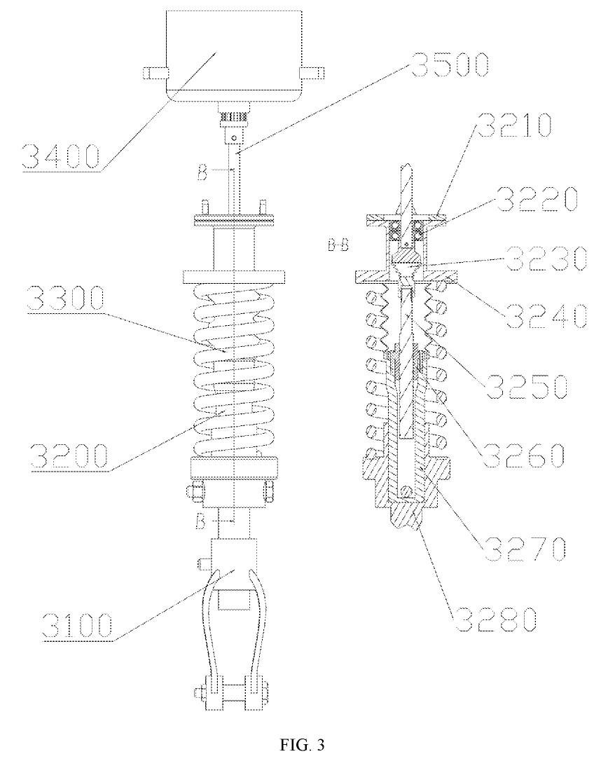

The vibration damping system (3000), as shown in FIG. 3, is connected with a lower control arm and a lower end of a steering arm housing of the suspension system, and used for actively controlling a suspension attitude and recovering wheel vibration energy through a vibration damping motor, and mitigating an impact on a road surface through a vibration damping spring. The vibration damping system mainly includes a vibration damping bracket (3100), an actuator (3200), a vibration damping spring (3300), a vibration damping motor (3400), and a vibration damping motor output shaft (3500).

The vibration damper bracket (3100) is used for supporting and positioning the vibration damping system (3000), wherein two supporting arms at a lower portion of the vibration damper bracket are provided with boss through holes to be connected with the lugs of the lower control arm (2200) through pins. As for the actuator (3200), a core of the actuator is a screw-nut electromechanical mechanism, and the actuator is fixedly connected with an upper mounting hole of the vibration damper bracket (3100) through bolts. The vibration damping spring (3300) is coaxially arranged with the actuator (3200) for supporting and impact mitigation. The vibration damping motor (3400) is a rotating motor, and used for actively controlling the suspension attitude and recovering the wheel vibration energy. The vibration damping motor output shaft (3500) is used for transmitting an output torque of the vibration damping motor (3400) to the actuator (3200), wherein a top end of the vibration damping motor output shaft is connected with an output end of the vibration damping motor (3400) through a spline, and a bottom end of the vibration damping motor output shaft is connected with the actuator (3200) through a pin.

The actuator (3200) mainly includes an actuator upper cover (3210), a double-row angular contact ball bearing (3220), a vibration damping system constant velocity universal joint (3230), an actuator upper shell (3240), a lead screw (3250), a ball nut (3260), an actuator connecting sleeve (3270) and an actuator lower shell (3280).

As for the actuator upper cover (3210), lugs are arranged at a top portion of the actuator upper cover to be connected with the lugs at the bottom end of the steering arm housing (2400) through bolts, a bottom portion of the actuator upper cover has a flange structure, and a through hole is arranged in a center of the actuator upper cover for the vibration damping motor output shaft (3500) to pass through. As for the double-row angular contact ball bearing (3220), an inner end of the double-row angular contact ball bearing is matched with the vibration damping motor output shaft (3500). As for the vibration damping system constant velocity universal joint (3230), a top portion of the vibration damping system constant velocity universal joint is connected with the bottom end of the vibration damping motor output shaft (3500) through a pin, and meanwhile, the double-row angular contact ball bearing (3220) is axially positioned. As for the actuator upper shell (3240), a top portion of the actuator upper shell is connected with the flange structure of the actuator upper cover (3210) through bolts, an exterior of the actuator upper shell is provided with a groove for positioning the vibration damping spring (3300), an interior of the actuator upper shell is matched with an outer end of the double-row angular contact ball bearing (3220), and a bottom portion of the actuator upper shell is provided with a dust cover to protect a transmission mechanism. As for the lead screw (3250), a top portion of the lead screw is connected with the vibration damping system constant velocity universal joint (3230) through a spline. The ball nut (3260) is matched with the lead screw (3250) to convert a rotary motion of the lead screw (3250) into a linear motion of the ball nut (3260). As for the actuator connecting sleeve (3270), a top portion of the actuator connecting sleeve is fixedly connected with the ball nut (3260) through a pin, and an interior of the actuator connecting sleeve is provided with a deep hole to supply sufficient space for the lead screw (3250). As for the actuator lower shell (3280), an interior of the actuator lower shell is matched with the actuator connecting sleeve (3270) and the actuator lower shell is connected with the actuator connecting sleeve through bolts, an exterior of the actuator lower shell is provided with a groove for positioning the vibration damping spring (3300), and a bottom portion of the actuator lower shell is provided with a supporting rod to be connected with the vibration damper bracket (3100).

The electromechanical braking system (4000) is connected with lugs on a left side of the steering knuckle in the suspension system through bolts, and used for providing a braking torque for vehicle driving. The electromechanical braking system mainly includes an electromechanical braking actuator, a brake caliper (4100), and a braking system housing (4200).

The electromechanical braking actuator mainly includes an electromechanical braking actuator motor, an electromechanical braking reducer and a transmission mechanism thereof, and is used for providing a brake clamping torque. The brake caliper (4100) is driven by the electromechanical braking actuator to clamp the brake disc (1500) to achieve a braking function. The braking system housing (4200) is used for protecting and positioning various devices inside the electromechanical braking system (4000), wherein lugs are arranged on two sides to be connected with the lugs on the left side of the steering knuckle (2300) through bolts at the same time.

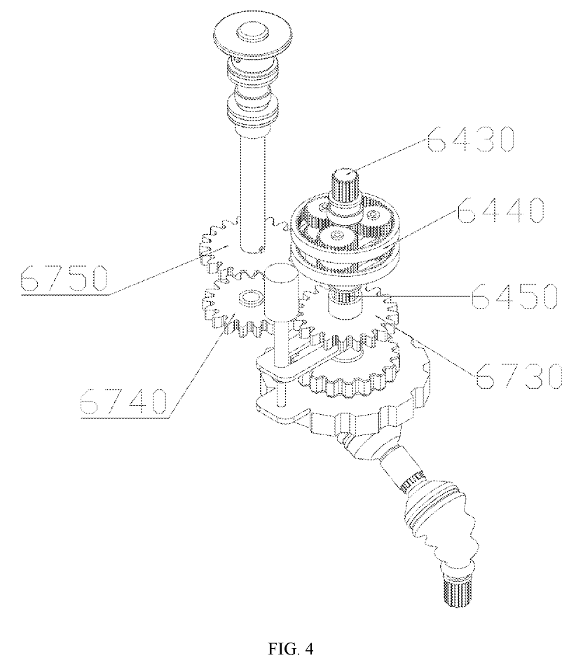

The steering system (6000), as shown in FIG. 2 and FIG. 4, is a kingpin steering and omni-directional steering dual-mode steering system, wherein an omni-directional steering mode serves as a redundancy scheme of a kingpin steering mode, and the same set of steering motor and planetary gear reducer is multiplexed in the two steering modes to work; when the kingpin steering mode is adopted, in the case of driving through the steering motor, speed reduction and torque multiplication through the planetary gear reducer, and connection with the steering knuckle of the suspension system through a universal transmission device, a steering torque is transmitted; when the omni-directional steering mode is adopted, in the case of driving through the steering motor, speed reduction and torque multiplication through the planetary gear reducer, and upward movements of a shift fork and a locking fork driven by a shift motor, a shift gear mechanism is driven to be disconnected from the universal transmission device and meshed with an omni-directional steering input gear, and finally, the steering torque output by the steering motor is output through an angle module output shaft, and meanwhile, an angle module quick interface is connected with the vehicle body to achieve omni-directional steering; and in addition, the upward movement of the locking fork drives a locking joint sleeve to be connected with a locking splined hub, and meanwhile, an external spline of the locking joint sleeve is connected with the steering arm housing of the suspension system, so that a locking function of the steering knuckle relative to the steering arm housing is achieved. The steering system mainly includes the steering motor (6100), the angle module output shaft (6200), a thrust bearing (6300), the planetary gear reducer (6400), a shift control mechanism (6500), the universal transmission device (6600) and a shift gearbox (6700).

The steering motor (6100) is a rotating motor, wherein lugs are arranged at a top portion of the steering motor to be connected with the steering arm (2600). The shift gearbox (6700) is an integrated device of shift and transmission devices of the kingpin steering and omni-directional steering dual-mode steering system, wherein a bottom portion of the shift gearbox is fixed by a positioning groove arranged in the steering arm housing (2400). As for the angle module output shaft (6200), a top portion of the angle module output shaft is connected with the angle module quick interface (2500) through a cylindrical pin, and a bottom portion of the angle module output shaft is connected with the shift gearbox (6700). The thrust bearing (6300) is sleeved in a middle portion of the angle module output shaft (6200), axially positioned by using a stepped hole in an outer side of the steering arm (2600), and matched with a deep groove ball bearing to jointly support the angle module output shaft (6200) in the stepped hole in the outer side of the steering arm (2600), so as to ensure that the angle module output shaft (6200) is positioned relative to the steering arm (2600). The planetary gear reducer (6400) plays a role of speed reduction and torque multiplication, wherein an upper end of the planetary gear reducer is connected with an output end of the steering motor (6100) through a spline, and a lower end of the planetary gear reducer is connected with the shift gear mechanism in the shift gearbox (6700) through a spline. The shift control mechanism (6500) is used for kingpin steering and omni-directional steering dual-mode switching. The universal transmission device (6600) includes two constant velocity universal joints, wherein an input end of a first constant velocity universal joint is connected with the shift gear mechanism in the shift gearbox (6700) through a spline, an output end of the first constant velocity universal joint is connected with an input end of a second constant velocity universal joint through a spline, and an output end of the second constant velocity universal joint is connected with an internal splined hole in a top portion of the steering knuckle (2300) through a spline.

The planetary gear reducer (6400) mainly includes a reducer housing (6410), a reducer upper cover (6420), an input splined shaft (6430), a two-stage planetary gear train (6440) and an output splined shaft (6450).

The reducer housing (6410) is used for positioning and protecting various transmission devices inside the planetary gear reducer (6400), wherein lugs are arranged on one side of an interior of the reducer housing provided with a rack structure and used with a positioning groove for mounting the shift motor of the shift control mechanism (6500). The reducer upper cover (6420) is connected with a top portion of the reducer housing (6410) through screws. As for the input splined shaft (6430), an upper end of the input splined shaft penetrates through a through hole arranged in a center of the reducer upper cover (6420), and the input splined shaft is connected with the output end of the steering motor (6100) through a spline. The two-stage planetary gear train (6440) includes two planetary gear mechanisms, wherein a rack part is provided by the rack structure arranged inside the reducer housing (6410), a primary sun gear is connected with the input splined shaft (6430) through a parallel key, a primary planetary carrier is connected with a secondary sun gear through a parallel key, and a bottom end of a secondary planetary carrier is provided with a parallel key; and connected with an upper end of an output splined shaft (6450) through the parallel key. As for the output splined shaft (6450), the upper end of the output splined shaft is connected with the secondary planetary carrier in the two-stage planetary gear train (6440) through the parallel key, and a lower end of the output splined shaft is connected with the shift gear mechanism in the shift gearbox (6700) through a spline.

The shift control mechanism (6500) mainly includes the shift motor (6510), a shift stepped shaft (6520), the shift fork (6530), the locking splined hub (6540), the locking fork (6550) and a locking joint sleeve (6560).

The shift motor (6510) is a linear motor, provides actuating power for the kingpin steering and omni-directional steering dual-mode switching, and is divided into “upper” and “lower” gears respectively corresponding to the two modes of omni-directional steering and kingpin steering, wherein an upper end of the shift motor is fixedly connected with the lugs on the outer side of the reducer housing (6410) and the positioning groove through bolts at the same time. The shift fork (6530) has a U-shape as a whole, wherein one side of the shift fork is provided with a through hole for axial positioning through the upper shaft shoulder of the shift stepped shaft (6520), and the shift fork is fixed through a fastening nut pair, and the other side of the shift fork is connected with the shift gear mechanism in the shift gearbox (6700). The locking splined hub (6540) is provided with an internal spline to be in splined connection with the input end of the first constant velocity universal joint of the universal transmission device (6600), and used for achieving a locking function of the steering knuckle (2300) relative to the steering arm housing (2400) when the system is in the omni-directional steering mode or is switched to the omni-directional steering mode. The locking fork (6550) has a U-shape as a whole, wherein one side of the locking fork is provided with a through hole for axial positioning through the lower shaft shoulder of the shift stepped shaft (6520), and the locking fork is fixed through a fastening nut pair, and the other side of the locking fork is inserted into the locking joint sleeve of the shift control mechanism (6500) for connection. The locking joint sleeve (6560) is provided with an external spline to be connected with the sliding spline of the through hole in the bottom portion of the steering arm housing (2400), and provided with a fork groove to be connected with the locking fork (6550). When the system is in the omni-directional steering mode or is switched to the omni-directional steering mode, the locking joint sleeve is driven to move up by the locking shift fork (6550), and connected with the locking splined hub (6540) through an internal spline arranged inside the locking joint sleeve, so as to achieve a locking function of the steering knuckle (2300) relative to the steering arm housing (2400).

The shift gearbox (6700) mainly includes a shift gearbox housing (6710), a shift gearbox upper cover (6720), the shift gear mechanism (6730), an omni-directional steering input gear (6740) and an omni-directional steering output gear (6750).

The shift gearbox housing (6710) is used for positioning and protecting various shift transmission devices inside the shift gearbox (6700), wherein a top portion of the shift gearbox housing is provided with a threaded hole, and a bottom portion of the shift gearbox housing is fixed by a positioning groove in the bottom portion of the steering arm housing (2400). The shift gearbox upper cover (6720) is provided with a through hole, and connected with a threaded hole in the top portion of the shift gearbox housing (6710) through a screw. The shift gear mechanism (6730) is composed of a shift gear and a shift shaft sleeve which are connected through a parallel key, wherein the shift gear is positioned through shaft shoulders of the shift shaft sleeve, the shift shaft sleeve is provided with the shift fork groove to be connected with the shift fork (6530), an upper end of the shift gear mechanism is provided with a splined hole to be constantly connected with the output splined shaft (6450), and meanwhile, sufficient axial displacement space is reserved for shift operation, and a lower end of the shift gear mechanism is provided with a splined hole. When the system is in the kingpin steering mode, the shift gear mechanism is controlled to move down by the shift control mechanism (6500) and connected with the universal transmission device (6600), and when the system is in the omni-directional steering mode, the shift gear mechanism is controlled to move up by the shift control mechanism (6500) and disconnected from the universal transmission device (6600). The omni-directional steering input gear (6740) is positioned by using a positioning pin of the shift gearbox housing (6710) and a boss through the shaft sleeve, so as to ensure that a target steering direction of the omni-directional steering mode is the same as that of the kingpin steering mode while transmitting a steering torque. When the system is in the kingpin steering mode, the shift gear mechanism (6730) is controlled to move down through the shift control mechanism (6500), so that the shift gear of the shift gear mechanism (6730) is connected with the omni-directional steering input gear (6740), and when the system is in the omni-directional steering mode, the shift gear mechanism (6730) is controlled to move up through the shift control mechanism (6500), so that the shift gear of the shift gear mechanism (6730) is offset from the omni-directional steering input gear (6740) for disconnection. The omni-directional steering output gear (6750) is connected with the angle module output shaft (6200) through a parallel key, axially positioned through a retaining ring, and constantly meshed with the omni-directional steering input gear (6740).

The super capacitor (5000) is mounted inside the steering arm housing in the suspension system, matched with a vehicle-mounted power battery, and used for providing electric energy for the hub motor of the suspension system, the vibration damping system, the electromechanical braking system and the steering system during working, and storing electric energy recovered from braking and vibration energy, so that self-energy storage and whole vehicle energy redundancy safety design of the kingpin steering and omni-directional steering dual-mode power-multiplexing electric wheel angle module are achieved.

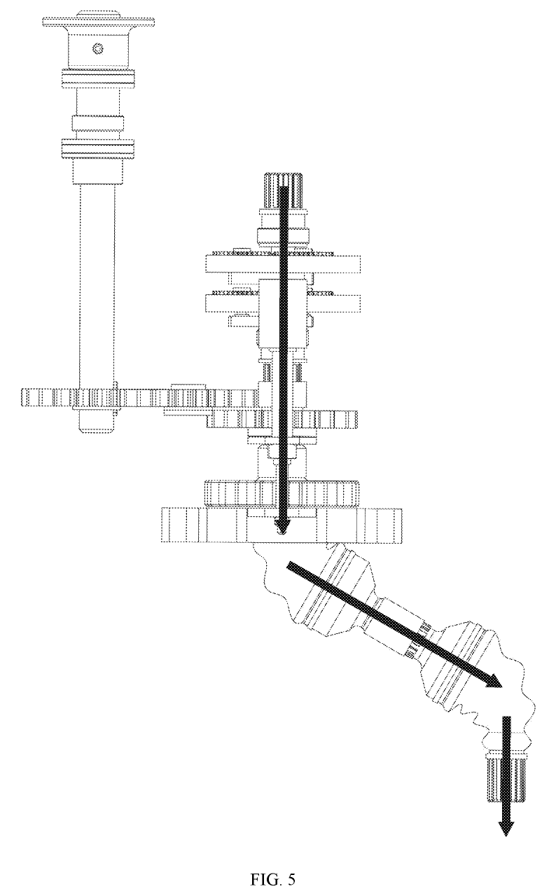

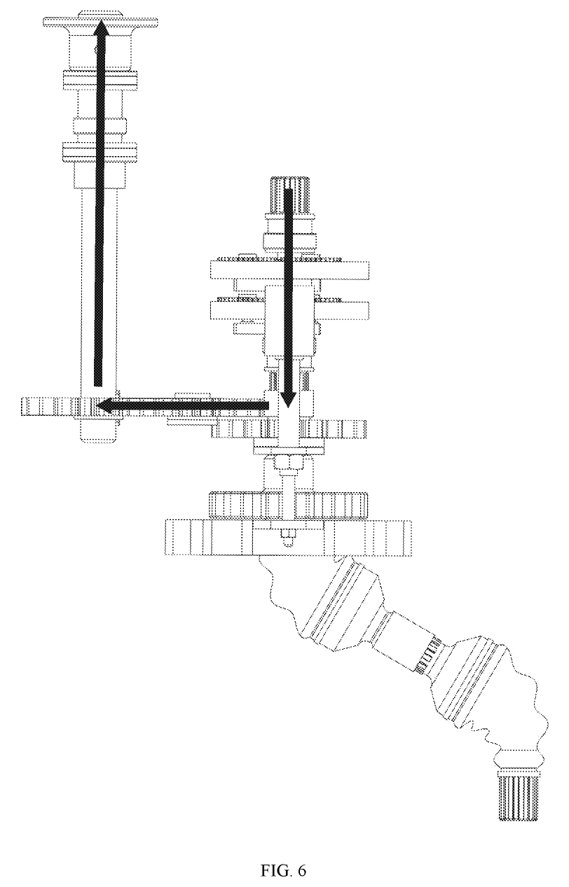

The present invention further provides a control method for the kingpin steering and omni-directional steering dual-mode power-multiplexing electric wheel angle module, wherein the steering system (6000) is a kingpin steering and omni-directional steering dual-mode steering system. Diagrams of torque transmission paths of the kingpin steering and omni-directional steering dual-mode power-multiplexing electric wheel angle module are as shown in FIG. 5 and FIG. 6, and working modes of the steering system include that:

the same set of steering motor (6100) and planetary gear reducer (6400) is multiplexed in the kingpin steering mode and the omni-directional steering mode to work;

in the kingpin steering mode, the shift motor (6510) is extended to be in a “down” gear position, and the shift fork (6530) and the locking fork (6550) move down synchronously, so that the shift shaft sleeve of the shift gear mechanism (6730) is connected with the universal transmission device (6600), and meanwhile, the locking joint sleeve (6560) moves down to be disconnected from the locking splined hub (6540) for unlocking, and in the case, the steering torque of the kingpin steering and omni-directional steering dual-mode power-multiplexing electric wheel angle module is provided by the steering motor (6100), subjected to the speed reduction and torque multiplication by the planetary gear reducer (6400), and then transmitted to the steering knuckle (2300) through the universal transmission device (6600), so that the kingpin steering and omni-directional steering dual-mode power-multiplexing electric wheel angle module actively controls conventional steering movement of the wheel unit (1000) around the kingpin according to a rotation signal of a steering wheel; and

in the omni-directional steering mode, the shift motor (6510) is retracted to be in an “up” gear position, and the shift fork (6530) and the locking fork (6550) move up synchronously, so that the shift shaft sleeve of the shift gear mechanism (6730) is disconnected from the universal transmission device (6600), the shift gear is meshed with the omni-directional steering input gear (6740), and meanwhile, the locking joint sleeve (6560) moves up to be connected with the locking splined hub (6540) for locking, and in the case, the steering torque of the kingpin steering and omni-directional steering dual-mode power-multiplexing electric wheel angle module is provided by the steering motor (6100), subjected to the speed reduction and torque multiplication by the planetary gear reducer (6400), finally transmitted to the angle module output shaft (6200) and the angle module quick interface (2500) for output through a meshing relationship of the shift gear of the shift gear mechanism (6730) with the omni-directional steering input gear (6740) and the omni-directional steering output gear (6750), and then transmitted to the steering knuckle (2300) through the universal transmission device (6600), so that the kingpin steering and omni-directional steering dual-mode power-multiplexing electric wheel angle module actively controls omni-directional steering of the wheel unit as a whole relative to the vehicle body according to the rotation signal of the steering wheel.

Control of kingpin steering and omni-directional steering dual-mode switching is mainly divided into passive control and active control, and the control method includes that:

under the passive control: the omni-directional steering mode serves as the steering redundancy scheme of the kingpin steering mode, and when the kingpin steering mode works normally, the kingpin steering mode is adopted to work; and when the kingpin steering mode fails to work, the mode is automatically switched to the omni-directional steering mode to work; and

under the active control: in the case that steering is not required or only steering at an angle below a threshold angle is required, which refers to no steering or small angle steering, the kingpin steering mode is adopted, which is usually used for steering at medium and high vehicle speeds; and in the case that steering above the threshold angle is required, which refers to large angle or full angle steering, the omni-directional steering mode is adopted, which is usually used for high-mobility steering at a low speed.

Firstly, it is judged whether the kingpin steering mode of the kingpin steering and omni-directional steering dual-mode power-multiplexing electric wheel angle module works normally. If the kingpin steering mode fails to work, the mode is automatically switched to the omni-directional steering mode which serves as a safety redundancy scheme, and if the kingpin steering mode works normally, it is further judged whether a target steering angle is higher than a threshold. If the target steering angle is lower than the threshold, the kingpin steering mode is selected to work, and if the target steering angle is higher than the threshold, the kingpin steering mode is switched to the omni-directional steering mode, and after confirming that the locking function of the steering knuckle (2300) relative to the steering arm housing (2400) has been completed, the omni-directional steering mode works officially. In addition, after finishing a steering instruction, wheels will be automatically straightened.

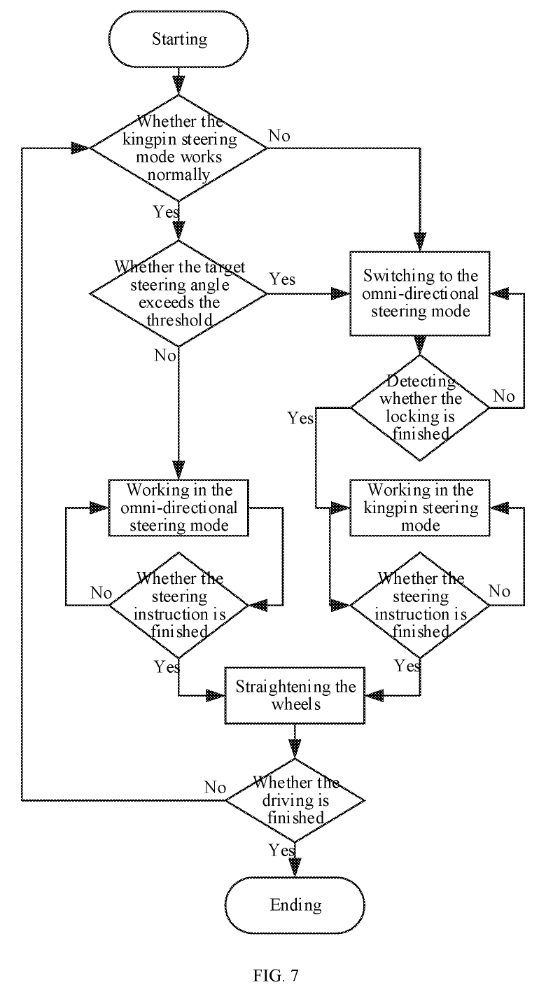

A specific flow of the control method is as shown in FIG. 7, and includes specific steps as follows:

step 0: starting;

step 1: judging whether the kingpin steering mode works normally, if the kingpin steering mode works normally, executing step 2, and if the kingpin steering mode does not work normally, executing step 5;

step 2: judging whether the target steering angle exceeds the threshold, if the target steering angle exceeds the threshold, executing step 5, if the target steering angle does not exceed the threshold, executing step 3;

step 3: selecting the kingpin steering mode to work, and executing step 4;

step 4: judging whether the steering instruction is finished, if the steering instruction is finished, executing step 9, and if the steering instruction is not finished, executing the step 3;

step 5: switching to the omni-directional steering mode, and executing step 6;

step 6: judging whether the locking is finished, if the locking is finished, executing step 7, and if the locking is not finished, executing the step 5;

step 7: selecting the omni-directional steering mode to work, and executing step 8;

step 8: judging whether the steering instruction is finished, if the steering instruction is finished, executing step 9, and if the steering instruction is not finished, executing the step 7;

step 9: straightening the wheels, and executing step 10;

step 10: judging whether a driving behavior is finished, if the driving behavior is finished, executing step 11, and if the driving behavior is not finished, executing the step 1; and

step 11: ending.

Although the implementation of the present invention has been disclosed above, it is not limited to the applications listed in the specification and the embodiments, and can be fully applied to various fields suitable for the present invention, and additional modifications can be easily implemented by those skilled in the art. Therefore, the present invention is not limited to the specific details and illustrations shown and described herein without departing from the general concept defined by the claims and the equivalent scope. Although the implementation of the present invention has been disclosed above, it is not limited to the applications listed in the specification and the embodiments, and can be fully applied to various fields suitable for the present invention, and additional modifications can be easily implemented by those skilled in the art. Therefore, the present invention is not limited to the specific details and illustrations shown and described herein without departing from the general concept defined by the claims and the equivalent scope.

We claim:

1. A kingpin steering and omni-directional steering dual-mode power-multiplexing electric wheel angle module, comprising:
a wheel unit (1000), which is connected with a steering knuckle in a suspension system through a hub bearing, and internally integrated with a hub motor at the same time, wherein the wheel unit is configured for supporting a vehicle load, and contacting with a road surface to transmit a driving or braking force and a cornering lateral force;
the suspension system (2000), which is an unequal-length double wishbone suspension, and mainly used for transmitting a force and a torque acting between wheels and a vehicle body, connecting various system components, and determining wheel positioning parameters;
a vibration damping system (3000), which is connected with a lower control arm and a lower end of a steering arm housing of the suspension system, and used for actively controlling a suspension attitude and recovering wheel vibration energy through a vibration damping motor, and mitigating an impact on a road surface through a vibration damping spring;
an electromechanical braking system (4000), which is connected with lugs on a left side of the steering knuckle in the suspension system through bolts, and used for providing a braking torque for vehicle driving;
a steering system (6000), which is a kingpin steering and omni-directional steering dual-mode steering system, wherein an omni-directional steering mode serves as a redundancy scheme of a kingpin steering mode, and the same set of steering motor and planetary gear reducer is multiplexed in the two steering modes to work; when the kingpin steering mode is adopted, in the case of driving through the steering motor, speed reduction and torque multiplication through the planetary gear reducer, and connection with the steering knuckle of the suspension system through a universal transmission device, a steering torque is transmitted; when the omni-directional steering mode is adopted, in the case of driving through the steering motor, speed reduction and torque multiplication through the planetary gear reducer, and upward movements of a shift fork and a locking fork driven by a shift motor, a shift gear mechanism is driven to be disconnected from the universal transmission device and meshed with an omni-directional steering input gear, and finally, the steering torque output by the steering motor is output through an angle module output shaft, and meanwhile, an angle module quick interface is connected with the vehicle body to achieve omni-directional steering; and in addition, the upward movement of the locking fork drives a locking joint sleeve to be connected with a locking splined hub, and meanwhile, an external spline of the locking joint sleeve is connected with the steering arm housing of the suspension system, so that a locking function of the steering knuckle relative to the steering arm housing is achieved; and
a super capacitor (5000), which is mounted inside the steering arm housing in the suspension system, matched with a vehicle-mounted power battery, and used for providing electric energy for the vibration damping system, the electromechanical braking system and the steering system during working, and storing electric energy recovered from braking and vibration energy, so that self-energy storage and whole vehicle energy redundancy safety design of the kingpin steering and omni-directional steering dual-mode power-multiplexing electric wheel angle module are achieved.

2. The kingpin steering and omni-directional steering dual-mode power-multiplexing electric wheel angle module according to claim 1, wherein the wheel unit (1000) comprises:
a tire (1100), which is used for bearing a whole vehicle load, and transmitting road force and torque;
a rim (1200), wherein an end portion of the rim is provided with spokes, an exterior of the rim is used for mounting the tire (1100), and a through hole is arranged inside a center of the rim;
a hub flange (1300), wherein an interior of the hub flange is provided with a through hole through which a positioning pin of an outer rotor of the hub motor (1400) penetrates for positioning, and the hub flange is connected with the spokes of the rim (1200) through flange nuts;
the hub motor (1400), which is a low-speed outer rotor hub motor, wherein a stator of the hub motor is connected with a through hole in a middle portion of the steering knuckle (2300) through bolts, the outer rotor of the hub motor is connected with the rim (1200) and the hub flange (1300) through rim bolts, and meanwhile, an outer ring of the outer rotor is provided with a threaded hole for mounting a brake disc (1500); and
the brake disc (1500), which is connected with the outer rotor of the hub motor (1400) through bolts, and provided with a brake clearance with a brake caliper in the electromechanical braking system (4000).

3. The kingpin steering and omni-directional steering dual-mode power-multiplexing electric wheel angle module according to claim 1, wherein the suspension system (2000) comprises:
the lower control arm (2100), which has an A-shape as a whole, and is provided with two intersected swing arms and one transverse arm, wherein a ball pin support is arranged at an intersected part of the swing arms and connected with a lower ball pin support of the steering knuckle (2300) through a ball pin, boss through holes are arranged in the other ends of the swing arms, and connected with a steering arm (2600) through shaft sleeves and bolts, and lugs are arranged on a top surface of the transverse arm to be connected with a vibration damper bracket in the vibration damping system (3000) through pins;
an upper control arm (2200), which has a V-shape as a whole, and is composed of two intersected swing arms, wherein a ball pin support is arranged at an intersected part of the swing arms and connected with an upper ball pin support of the steering knuckle (2300) through a ball pin, and boss through holes are arranged in the other ends of the swing arms, and connected with the steering arm (2600) through shaft sleeves and bolts;
the steering knuckle (2300), wherein a center connecting line between the ball pin supports of the upper and lower control arms forms a kingpin, a through hole is arranged in a middle portion of the steering knuckle for mounting a stator of the hub motor (1400), and lugs are arranged on a left side of the steering knuckle for bolt connection with the electromechanical braking system (4000);
the steering arm housing (2400), which is mainly used for arranging and positioning various system components, and protecting the system components from being damaged, wherein an upper end of the steering arm housing is provided with a bolt hole, a bottom portion of the steering arm housing is provided with a through hole, and meanwhile, an inner side of the through hole is provided with a sliding spline;
the angle module quick interface (2500), wherein a top portion of the angle module quick interface is connected with the vehicle body, and a bottom portion of the angle module quick interface is connected with the angle module output shaft of the steering system (6000) through a cylindrical pin; and
the steering arm (2600), which is an L-shaped bracket as a whole, wherein two sides of a lower end of the steering arm are connected with the boss through holes of the lower control arm (2100) through the shaft sleeves and the bolts, lugs are arranged on an inner side of a middle portion of the steering arm to be connected with the boss through holes of the upper control arm (2200) through the shaft sleeves and the bolts, symmetrical reinforcing ribs are additionally arranged at an L-shaped corner, an upper end of the steering arm is provided with a threaded hole for mounting the steering motor of the steering system (6000), and an outer edge of a top portion of the steering arm (2600) is provided with a bolt hole for mounting the steering arm housing (2400).

4. The kingpin steering and omni-directional steering dual-mode power-multiplexing electric wheel angle module according to claim 3, wherein the vibration damping system (3000) comprises:
the vibration damper bracket (3100), which is used for supporting and positioning the vibration damping system (3000), wherein two supporting arms at a lower portion of the vibration damper bracket are provided with boss through holes to be connected with the lugs of the lower control arm (2200) through pins;
an actuator (3200), wherein a core of the actuator is a screw-nut electromechanical mechanism, and the actuator is fixedly connected with an upper mounting hole of the vibration damper bracket (3100) through bolts;
a vibration damping spring (3300), which is coaxially arranged with the actuator (3200) for supporting and impact mitigation;
the vibration damping motor (3400), which is a rotating motor, and used for actively controlling the suspension attitude and recovering the wheel vibration energy; and
a vibration damping motor output shaft (3500), which is used for transmitting an output torque of the vibration damping motor (3400) to the actuator (3200), wherein a top end of the vibration damping motor output shaft is connected with an output end of the vibration damping motor (3400) through a spline, and a bottom end of the vibration damping motor output shaft is connected with the actuator (3200) through a pin;
wherein, the actuator (3200) comprises:
an actuator upper cover (3210), wherein lugs are arranged at a top portion of the actuator upper cover to be connected with the lugs at the bottom end of the steering arm housing (2400) through bolts, a bottom portion of the actuator upper cover has a flange structure, and a through hole is arranged in a center of the actuator upper cover for the vibration damping motor output shaft (3500) to pass through;
a double-row angular contact ball bearing (3220), wherein an inner end of the double-row angular contact ball bearing is matched with the vibration damping motor output shaft (3500);
a vibration damping system constant velocity universal joint (3230), wherein a top portion of the vibration damping system constant velocity universal joint is connected with the bottom end of the vibration damping motor output shaft (3500) through a pin, and meanwhile, the double-row angular contact ball bearing (3220) is axially positioned;
an actuator upper shell (3240), wherein a top portion of the actuator upper shell is connected with the flange structure of the actuator upper cover (3210) through bolts, an exterior of the actuator upper shell is provided with a groove for positioning the vibration damping spring (3300), an interior of the actuator upper shell is matched with an outer end of the double-row angular contact ball bearing (3220), and a bottom portion of the actuator upper shell is provided with a dust cover to protect a transmission mechanism;
a lead screw (3250), wherein a top portion of the lead screw is connected with the vibration damping system constant velocity universal joint (3230) through a spline;
a ball nut (3260), which is matched with the lead screw (3250) to convert a rotary motion of the lead screw (3250) into a linear motion of the ball nut (3260);
an actuator connecting sleeve (3270), wherein a top portion of the actuator connecting sleeve is fixedly connected with the ball nut (3260) through a pin, and an interior of the actuator connecting sleeve is provided with a deep hole to supply sufficient space for the lead screw (3250); and
an actuator lower shell (3280), wherein an interior of the actuator lower shell is matched with the actuator connecting sleeve (3270) and the actuator lower shell is connected with the actuator connecting sleeve through bolts, an exterior of the actuator lower shell is provided with a groove for positioning the vibration damping spring (3300), and a bottom portion of the actuator lower shell is provided with a supporting rod to be connected with the vibration damper bracket (3100).

5. The kingpin steering and omni-directional steering dual-mode power-multiplexing electric wheel angle module according to claim 3, wherein the electromechanical braking system (4000) comprises:
an electromechanical braking actuator, which mainly comprises an electromechanical braking actuator motor, an electromechanical braking reducer and a transmission mechanism thereof, and is used for providing a brake clamping torque;
a brake caliper (4100), which is driven by the electromechanical braking actuator to clamp the brake disc (1500) to achieve a braking function; and
a braking system housing (4200), which is used for protecting and positioning various devices inside the electromechanical braking system (4000), wherein lugs are arranged on two sides to be connected with the lugs on the left side of the steering knuckle (2300) through bolts at the same time.

6. The kingpin steering and omni-directional steering dual-mode power-multiplexing electric wheel angle module according to claim 3, wherein the steering system (6000) comprises:
the steering motor (6100), which is a rotating motor, wherein lugs are arranged at a top portion of the steering motor to be connected with the steering arm (2600);
a shift gearbox (6700), which is an integrated device of shift and transmission devices of the kingpin steering and omni-directional steering dual-mode steering system, wherein a bottom portion of the shift gearbox is fixed by a positioning groove arranged in the steering arm housing (2400); the angle module output shaft (6200), wherein a top portion of the angle module output shaft is connected with the angle module quick interface (2500) through a cylindrical pin, and a bottom portion of the angle module output shaft is connected with the shift gearbox (6700);
a thrust bearing (6300), which is sleeved in a middle portion of the angle module output shaft (6200), axially positioned by using a stepped hole in an outer side of the steering arm (2600), and matched with a deep groove ball bearing to jointly support the angle module output shaft (6200) in the stepped hole in the outer side of the steering arm (2600), so as to ensure that the angle module output shaft (6200) is positioned relative to the steering arm (2600);
the planetary gear reducer (6400), which plays a role of speed reduction and torque multiplication, wherein an upper end of the planetary gear reducer is connected with an output end of the steering motor (6100) through a spline, and a lower end of the planetary gear reducer is connected with the shift gear mechanism in the shift gearbox (6700) through a spline;
a shift control mechanism (6500), which is used for kingpin steering and omni-directional steering dual-mode switching; and
the universal transmission device (6600), which comprises two constant velocity universal joints, wherein an input end of a first constant velocity universal joint is connected with the shift gear mechanism in the shift gearbox (6700) through a spline, an output end of the first constant velocity universal joint is connected with an input end of a second constant velocity universal joint through a spline, and an output end of the second constant velocity universal joint is connected with an internal splined hole in a top portion of the steering knuckle (2300) through a spline.

7. The steering system (6000) according to claim 6, wherein the planetary gear reducer (6400) comprises:
a reducer housing (6410), which is used for positioning and protecting various transmission devices inside the planetary gear reducer (6400), wherein lugs are arranged on one side of an interior of the reducer housing provided with a rack structure and used with a positioning groove for mounting the shift motor of the shift control mechanism (6500);
a reducer upper cover (6420), which is connected with a top portion of the reducer housing (6410) through screws;
an input splined shaft (6430), wherein an upper end of the input splined shaft penetrates through a through hole arranged in a center of the reducer upper cover (6420), and the input splined shaft is connected with the output end of the steering motor (6100) through a spline;
a two-stage planetary gear train (6440), which comprises two planetary gear mechanisms, wherein a rack part is provided by the rack structure arranged inside the reducer housing (6410), a primary sun gear is connected with the input splined shaft (6430) through a parallel key, a primary planetary carrier is connected with a secondary sun gear through a parallel key, and a bottom end of a secondary planetary carrier is provided with a parallel key; and connected with an upper end of an output splined shaft (6450) through the parallel key; and
the output splined shaft (6450), wherein the upper end of the output splined shaft is connected with the secondary planetary carrier in the two-stage planetary gear train (6440) through the parallel key, and a lower end of the output splined shaft is connected with the shift gear mechanism in the shift gearbox (6700) through a spline.

8. The steering system (6000) according to claim 7, wherein the shift control mechanism (6500) comprises:
the shift motor (6510), which is a linear motor, provides actuating power for the kingpin steering and omni-directional steering dual-mode switching, and is divided into “upper” and “lower” gears respectively corresponding to the two modes of omni-directional steering and kingpin steering, wherein an upper end of the shift motor is fixedly connected with the lugs on the outer side of the reducer housing (6410) and the positioning groove through bolts at the same time;
a shift stepped shaft (6520), which adopts a stepped shaft design, wherein an upper end of the shift stepped shaft is connected with an output end of the shift motor (6510), and the shift stepped shaft is provided with upper and lower shaft shoulders;
the shift fork (6530), which has a U-shape as a whole, wherein one side of the shift fork is provided with a through hole for axial positioning through the upper shaft shoulder of the shift stepped shaft (6520), and the shift fork is fixed through a fastening nut pair, and the other side of the shift fork is connected with the shift gear mechanism in the shift gearbox (6700);
the locking splined hub (6540), which is provided with an internal spline to be in splined connection with the input end of the first constant velocity universal joint of the universal transmission device (6600), and used for achieving a locking function of the steering knuckle (2300) relative to the steering arm housing (2400) when the system is in the omni-directional steering mode or is switched to the omni-directional steering mode;
the locking fork (6550), which has a U-shape as a whole, wherein one side of the locking fork is provided with a through hole for axial positioning through the lower shaft shoulder of the shift stepped shaft (6520), and the locking fork is fixed through a fastening nut pair, and the other side of the locking fork is inserted into the locking joint sleeve of the shift control mechanism (6500) for connection; and
the locking joint sleeve (6560), which is provided with an external spline to be connected with the sliding spline of the through hole in the bottom portion of the steering arm housing (2400), and provided with a fork groove to be connected with the locking fork (6550), wherein, when the system is in the omni-directional steering mode or is switched to the omni-directional steering mode, the locking joint sleeve is driven to move up by the locking shift fork (6550), and connected with the locking splined hub (6540) through an internal spline arranged inside the locking joint sleeve, so as to achieve a locking function of the steering knuckle (2300) relative to the steering arm housing (2400).

9. The steering system (6000) according to claim 8, wherein the shift gearbox (6700) comprises:
a shift gearbox housing (6710), which is used for positioning and protecting various shift transmission devices inside the shift gearbox (6700), wherein a top portion of the shift gearbox housing is provided with a threaded hole, and a bottom portion of the shift gearbox housing is fixed by a positioning groove in the bottom portion of the steering arm housing (2400);
a shift gearbox upper cover (6720), which is provided with a through hole, and connected with a threaded hole in the top portion of the shift gearbox housing (6710) through a screw;
the shift gear mechanism (6730), which is composed of a shift gear and a shift shaft sleeve which are connected through a parallel key, wherein the shift gear is positioned through shaft shoulders of the shift shaft sleeve, the shift shaft sleeve is provided with the shift fork groove to be connected with the shift fork (6530), an upper end of the shift gear mechanism is provided with a splined hole to be constantly connected with the output splined shaft (6450), and meanwhile, sufficient axial displacement space is reserved for shift operation, and a lower end of the shift gear mechanism is provided with a splined hole, wherein, when the system is in the kingpin steering mode, the shift gear mechanism is controlled to move down by the shift control mechanism (6500) and connected with the universal transmission device (6600), and when the system is in the omni-directional steering mode, the shift gear mechanism is controlled to move up by the shift control mechanism (6500) and disconnected from the universal transmission device (6600);
an omni-directional steering input gear (6740), which is positioned by using a positioning pin of the shift gearbox housing (6710) and a boss through the shaft sleeve, so as to ensure that a target steering direction of the omni-directional steering mode is the same as that of the kingpin steering mode while transmitting a steering torque, wherein, when the system is in the kingpin steering mode, the shift gear mechanism (6730) is controlled to move down through the shift control mechanism (6500), so that the shift gear of the shift gear mechanism (6730) is connected with the omni-directional steering input gear (6740), and when the system is in the omni-directional steering mode, the shift gear mechanism (6730) is controlled to move up through the shift control mechanism (6500), so that the shift gear of the shift gear mechanism (6730) is offset from the omni-directional steering input gear (6740) for disconnection; and
an omni-directional steering output gear (6750), which is connected with the angle module output shaft (6200) through a parallel key, axially positioned through a retaining ring, and constantly meshed with the omni-directional steering input gear (6740).

10. The kingpin steering and omni-directional steering dual-mode power-multiplexing electric wheel angle module according to claim 9, wherein the steering system (6000) is a kingpin steering and omni-directional steering dual-mode steering system, and working modes and control methods of the steering system comprise that:
the same set of steering motor (6100) and planetary gear reducer (6400) is multiplexed in the kingpin steering mode and the omni-directional steering mode to work;
in the kingpin steering mode, the shift motor (6510) is extended to be in a “down” gear position, and the shift fork (6530) and the locking fork (6550) move down synchronously, so that the shift shaft sleeve of the shift gear mechanism (6730) is connected with the universal transmission device (6600), and meanwhile, the locking joint sleeve (6560) moves down to be disconnected from the locking splined hub (6540) for unlocking, and in the case, the steering torque of the kingpin steering and omni-directional steering dual-mode power-multiplexing electric wheel angle module is provided by the steering motor (6100), subjected to the speed reduction and torque multiplication by the planetary gear reducer (6400), and then transmitted to the steering knuckle (2300) through the universal transmission device (6600), so that the kingpin steering and omni-directional steering dual-mode power-multiplexing electric wheel angle module actively controls conventional steering movement of the wheel unit (1000) around the kingpin according to a rotation signal of a steering wheel; and
in the omni-directional steering mode, the shift motor (6510) is retracted to be in an “up” gear position, and the shift fork (6530) and the locking fork (6550) move up synchronously, so that the shift shaft sleeve of the shift gear mechanism (6730) is disconnected from the universal transmission device (6600), the shift gear is meshed with the omni-directional steering input gear (6740), and meanwhile, the locking joint sleeve (6560) moves up to be connected with the locking splined hub (6540) for locking, and in the case, the steering torque of the kingpin steering and omni-directional steering dual-mode power-multiplexing electric wheel angle module is provided by the steering motor (6100), subjected to the speed reduction and torque multiplication by the planetary gear reducer (6400), finally transmitted to the angle module output shaft (6200) and the angle module quick interface (2500) for output through a meshing relationship of the shift gear of the shift gear mechanism (6730) with the omni-directional steering input gear (6740) and the omni-directional steering output gear (6750), and then transmitted to the steering knuckle (2300) through the universal transmission device (6600), so that the kingpin steering and omni-directional steering dual-mode power-multiplexing electric wheel angle module actively controls omni-directional steering of the wheel unit as a whole relative to the vehicle body according to the rotation signal of the steering wheel;
control of kingpin steering and omni-directional steering dual-mode switching is mainly divided into passive control and active control, and comprises that:
under the passive control: the omni-directional steering mode serves as the steering redundancy scheme of the kingpin steering mode, and when the kingpin steering mode works normally, the kingpin steering mode is adopted to work; and when the kingpin steering mode fails to work, the mode is automatically switched to the omni-directional steering mode to work; and
under the active control: in the case that steering is not required or only steering at an angle below a threshold angle is required, which refers to no steering or small angle steering, the kingpin steering mode is adopted, which is usually used for steering at medium and high vehicle speeds; and in the case that steering above the threshold angle is required, which refers to large angle or full angle steering, the omni-directional steering mode is adopted, which is usually used for high-mobility steering at a low speed.
